(19) United States
(12) Patent Application Publication
(10) Pub. No.: US 2004/0191637 A1
(43) Pub. Date: Sep. 30, 2004

(54) Method for packaging thermally compensated filters

(76) Inventors: Gregory Steckman, San Gabriel, CA (US); Charles Williams, Diamond Bar, CA (US); Christophe Moser, Pasadena, CA (US)

Correspondence Address: J. D. Harriman II, COUDERT BROTHER LLP, 23rd Floor, 333 South Hope Street, Los Angeles, CA, 90071, US

(21) Appl. No.: 10/809,969

(22) Filed: Mar. 25, 2004

Related U.S. Application Data
(60) Provisional application No. 60/457,394, filed on Mar. 25, 2003.

(51) Int. Cl. G03H 1/04

(52) U.S. Cl. 430/1; 430/2; 430/321; 359/3

(57) ABSTRACT

The invention is a method of packaging volume holographic filters to modify the temperature sensitivity using fixed volume holographic grating filters (VHG). These filters are recorded using either a phase mask or a two-beam method. A mechanical constraint is provided to the filter by way of a stress. This stress can be applied equally to both simple reflection grating as well as slanted reflection grating. One way is to use a filter-anisotropic tube arrangement where the tube is made by either stacking washers of precise inner diameter or by wrapping a wire around a central filter core. To modify the thermal wavelength coefficient of the filter, clamps comprising plates and screws are used, the filter is inserted into a substrate, or the filter is sandwiched between substrates.

### CROSS-REFERENCE TO RELATED APPLICATION(S)

The present-application claims the benefit of priority from pending U.S. Provisional Patent Application No. 60/457,394, entitled “Method for Packaging Thermally Compensated Filters”, filed on Mar. 25, 2003, which is herein incorporated by reference in its entirety.

### BACKGROUND OF THE INVENTION

2. Field of the Invention

The present invention relates to volume holographic filters, and in particular to a method of packaging volume holographic filters to achieve temperature insensitivity.

Portions of the disclosure of this patent document contain material that are subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Digital and analog information is often communicated using optical fibers. In some schemes, many signals, each with its own optical wavelength, are communicated on the same optical fiber. At some point, it is necessary to extract a signal (i.e. a particular optical wavelength) from the optical fiber, and this is accomplished with a drop filter. A problem with prior art drop filters is that they are limited to a single fixed optical wavelength. This problem can be understood by a review of optical signal transmission schemes.

Optical Signal Transmission Scheme

With the increase of data transfer due to the popularity and ease of use of the Internet, there is a need to increase the volume (commonly termed bandwidth) of data that can be transmitted across a network of computing devices. Initially, optical fiber networks carried only a single signal at a single wavelength. A scheme using wavelength division multiplexing (WDM) has significantly enabled increases to the aggregate volume of data that can be transmitted over a network like the Internet.

The basic concept of WDM is to insert and remove multiple data channels in and out of an optical fiber. Prior to the use of WDM, most optical fibers were used to unidirectionally carry only a single data channel at one wavelength. WDM divides a network's bandwidth into channels, with each channel assigned a particular wavelength. This allows multiple channels (each at a different wavelength) to be carried on the same transmission medium simultaneously. Each data channel is transmitted at a unique wavelength, and the wavelengths are appropriately selected such that the channels do not interfere with each other, and the optical transmission losses of the fiber are low. The gain in the network bandwidth is given by the aggregation of multiple single channel bandwidths.

The channels in a WDM system are multiplexed at a transmitting end and transmitted to a receiving end where they are demultiplexed into individual channels. In the existing systems, the transmitting and receiving ends must be tuned to the same wavelengths to be able to communicate. That is, the transmitting and receiving ends use a filter to insert or retrieve the correct signal frequency. Prior art filter implementations include Fiber Bragg Gratings (FBGs) or Thin Film Filters (TFFs), both of which have inherent features not completely suitable for certain kinds of applications.

There are many applications that require a bulk medium and hence are not able to use FBGs even though FBGs have many uses in high end filtering applications in fiber optics communication systems and as a temperature, pressure, strain, and other sensors. Another drawback with the FBG filter is its high cost because of additional components (circulators) that are required to separate the reflected light from the input fiber. TFFs are becoming the prevailing choice for fixed filters in communication systems because they do not require external components as in the case with FBGs, even though the filtering capabilities of TFFs are limited to broad filters (in the 100 to 400 GHz range), which reduce the number of channels (traffic capacity) per fiber.

There is a need to use a kind of filter that combines the best attributes of both the FBGs and the TFFs, and is also athermalized. There is also the need to minimize the size of the filter and hence the cost, yet be able to athermalized the filter in order to reduce system cost.

### SUMMARY OF THE INVENTION

The present invention relates to a method of packaging volume holographic filters to achieve temperature insensitivity (to be athermalized, or thermally compensated). According to one embodiment of the present invention, a fixed volume holographic grating filter (FVHGF, or simply VHG) is used. According to one embodiment of the VHG, it is holographically recorded using either a phase mask or a two-beam method. According to another embodiment of the VHG, it is thermally compensated by means of a tube geometry. According to another embodiment of the present invention, a mechanical constraint is provided to the filter such that when the thermal expansion is in the direction where the filtering occurs, the filter is clamped to a pre-set value insensitive with the change in temperature or the temperature is able to modify the filter. According to one embodiment of the mechanical constraint, a strain is induced to tailor the thermal wavelength coefficient (C_{tλ}) of the VHG for a particular application. According to another embodiment of the mechanical constraint, it can be applied equally to a simple reflection grating as well as to a slanted reflection grating. According to another embodiment of the present invention, a grating chirp can be introduced in the VHG.

According to another embodiment of the present invention, anisotropic tubes are generated for minimizing frictional forces along the boundary of the filter tube. According to one embodiment, anisotropic tubes are generated with a stack of washers containing precise inner diameter openings. According to another embodiment, anisotropic tubes are generated by wrapping a thread or wire of material around the filter which forms a core. According to another embodiment of the present invention, a clamp arrangement comprising of plates and attaching means is used to modify C_{Tλ}. According to one embodiment of the clamp, the attaching means and plates are made of steel (or other material) with a relatively high thermal coefficient of expansion (16 ppm/° C.), while the spacers are made of quartz (or other material) with a relatively low thermal coefficient of expansion (0.5 ppm/° C.). According to another embodiment of the present invention, the VHG is inserted into a substrate with a lower thermal expansion coefficient. According to another embodiment of the present invention, the VHG is bonded between two pieces of a substrate material with a different thermal expansion coefficient.

### BRIEF DESCRIPTION OF THE DRAWINGS

These and other features, aspects and advantages of the present invention will become better understood with regard to the following description, appended claims and accompanying drawings where:

FIG. 1 illustrates a front and side view of the tube geometry, according to one embodiment of the present invention.

FIG. 2 illustrates one method to create a tube-filter combination, according to one embodiment of the present invention.

FIG. 3 illustrates another method to create a tube-filter combination, according to one embodiment of the present invention.

FIG. 4 illustrates a top and side view of a clamp arrangement, according to one embodiment of the present invention.

FIG. 5 illustrates a graph of the results of an experiment conducted by the applicants.

FIG. 6 illustrates a top and side view of a compensating substrate approach, according to one embodiment of the present invention.

FIG. 7 illustrates a compensating sandwich approach, according to one embodiment of the present invention.

FIG. 8 illustrates a flowchart illustrating variation in chirp with a variation in the temperature, according to one embodiment of the present invention.

FIG. 9 illustrates a flowchart illustrating variation in chirp with a variation in the temperature, according to another embodiment of the present invention.

### DETAILED DESCRIPTION OF THE INVENTION

The embodiments of the present invention are a method for packaging volume holographic filters to achieve temperature insensitivity (to be athermalized, or thermally compensated). In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

Fixed Volume Holographic Grating Filters (VHG)

According to one embodiment of the present invention, a VHG is used unlike prior art methods that use FBG or TFF. There is an advantage of using a VHG, namely, the recording medium for the grating is a bulk medium unlike single mode fiber found in FBG. VHG combines the best attributes of both FBGs and TFFs by providing narrow band filters and alleviating the need for additional components. According to one embodiment of the VHG, it is holographically recorded either with a phase mask or by a two-beam method. In either case, the VHG has a grating vector associated with it, which describes the orientation and magnitude of the grating within the holographic material. For a simple reflection grating, the Bragg wavelength is

λ_{B}=2nΛ (1)

where λ_{B} is the Bragg wavelength, n is the average index of refraction of the material, and Λ is the grating fringe spacing.

For most materials capable of forming VHG's, the wavelength λ_{B} will drift with the temperature of the filter (referred to here as the thermal wavelength coefficient C_{Tλ}). This is due to a combination of the variation of the bulk index of refraction n with temperature, and the thermal expansion coefficient of the material which modifies the effective grating fringe spacing. In some cases, these two effects counter each other, and in others they add to increase the thermal wavelength coefficient. In either case, the net effect is typically not zero resulting in the drifting of the Bragg wavelength.

Thermal Compensation Methods

There are several techniques that can be used to thermally compensate volume Bragg grating filters by inducing a strain to tailor the C_{Tλ} for a particular application. These methods are described below. Although only the case of a simple reflection grating is described here for convenience, these methods apply equally well to slanted reflection gratings. Differentiating (1) above with respect to temperature gives:

δλ_{B}/δT=C_{Tλ}=2Λ(δn /δT)+2n(δΛ/δT) (2)

If stress is applied directly along the grating vector, the wavelength change is given by:

Δλ_{Bσ}=2nΛ(σ/E) (3)

where σ is the stress applied and E is Young's modulus for the holographic material being used. If the stress is applied perpendicularly to the grating vector, there is still a shift of the Bragg wavelength, but scaled by Poisson's ratio μ such that:

Δλ_{Bσ}=2nΛγμ(σ/E) (4)

where γ is a geometry dependent factor.

In both cases (applying stress directly along the grating vector and perpendicular to the grating vector), if the stress is varied with temperature then the Bragg wavelength will also change with temperature and C_{Tλ} is modified.

According to one embodiment of the VHG, it is thermally compensated by means of a tube geometry. In this configuration, a cylindrically or similarly formed filter is fitted within a compensating tube made of a material with a coefficient of thermal expansion that is different than that of the filter material. When the temperature is varied, the tube and the filter exert forces on each other determined by the dimensions of the materials, their relative stiffness, and their thermal expansion coefficients. The net force either causes an expansion or a contraction of the filter material in the direction along the length of the tube. Since the grating k-vector has a component along this coordinate, the filter's Bragg wavelength is affected according to equation (4) above with a γ factor greater than 2, resulting in a modified C_{Tλ} of the filter as required by the application.

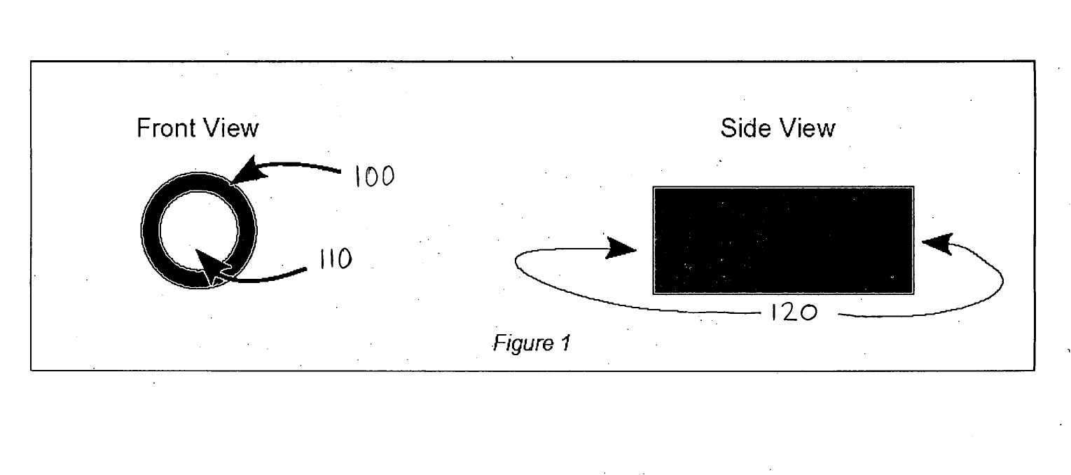

FIG. 1 illustrates a front and side view of the tube geometry discussed above. In the front view, compensating tube 100 encircles filter 110. The side view shows the outer compensating tube with readout surfaces 120 of the filter on either end of the tube. Combining the side and front views, one can see that the tube along with the enclosed filter is cylindrical in shape. It should be noted that the cylindrical shape is only one of many other shapes that can perform the function of thermally compensating the filter, with the only criteria being that the tube has a different coefficient of thermal expansion than the filter.

The rate of expansion or contraction of the filter as a function of temperature is controlled by several parameters, which can be varied to tailor the net thermal wavelength coefficient, C_{Tλ} of the filter as required by an application. The following are some of the parameters, and include:

(1) The thermal expansion coefficient of the tube material. This may be anisotropic.

(2) The thermal expansion coefficient of the filter material. This may be anisotropic.

(3) The thickness of the walls of the tube.

(4) The diameter of the filter (or conversely, the diameter of the tube).

(5) The Young's modulus of the tube and filter materials.

(6) The Poisson's ratio of the filter material.

The above mentioned partial list of parameters determines the filter assembly's thermal wavelength coefficient. The operating point, or values, of the passband center wavelength can also be controlled by a proper choice of geometry, temperature, and grating k-vector. By under or over sizing the inner diameter of the tube with respect to the filter diameter, the tube and filter materials are required to be set at a precise temperature to allow the two to fit precisely together. The desired passband center wavelength can be set at the time of assembly by utilizing the properly sized tube and temperature, given a fixed grating.

Besides affecting the thermal wavelength coefficient, by designing the tube-filter assembly to realize a stress that varies along the length of the tub, a grating chirp may be introduced (i.e. a modification of the filter to produce a modified frequency filtering effect). According to one embodiment, the filter assembly can be designed to give a fixed amount of grating chirp determined by the assembly conditions. According to another embodiment, the filter assembly can be designed to give a chirp that varies with temperature, thus allowing a temperature chirp-tuned filter. Although only a simple reflection grating is described here, these methods apply equally well to slanted reflection gratings.

Chirp

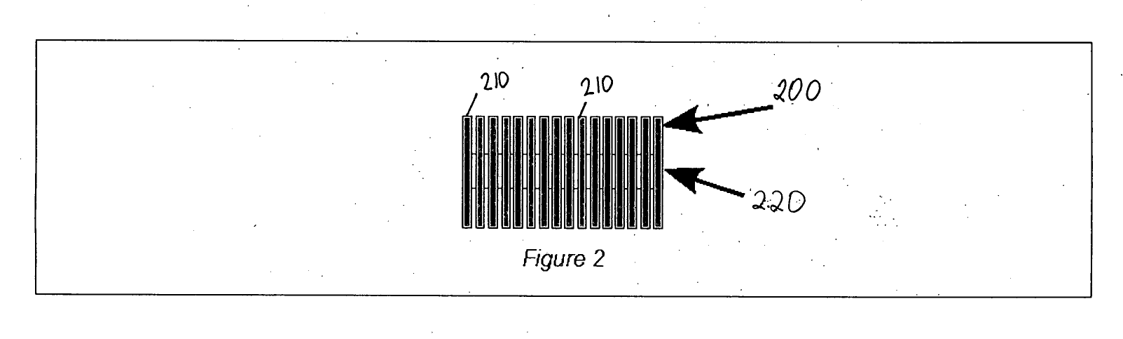

According to one embodiment, the filter material has an unchirped VHG recorded in its unpackaged state. This means that the temperature at which the packaging is performed is taken as the “no stress” temperature, and the grating is in its natural or unchirped state. When the temperature changes, the stress on the grating material will vary along the length of the grating. According to one embodiment, the stiffness of the material can be varied from one end to the other when using an anisotropic tube made from a stack of washers (see below, and FIG. 2). For example, a less stiff material can be used at one end, with a gradual increase in the stiffness of the material to the other end. This means that when the temperature changes from its “no stress” state, the force or stress on one end will be greater than the other which causes the grating spacing to vary from one end to the other. According to another embodiment, the washer material has a uniform stiffness but with a varying coefficient of thermal expansion, or a combination of varying stiffness and coefficient of thermal expansion. These are just two examples of activating a chirp within a VHG and there can be other methods without departing from the scope of the present invention. According to another embodiment, the VHG is recorded so that there is a chirp (natural chirp) when the filter is in the “no stress” state and the stress acts to counter the natural chirp to reduce it.

Thus, the chirp either varies in the same way as the change in the temperature (increase in temperature increases the chirp and a decrease in temperature decreases the chirp), or varies in opposite ways (increase in temperature decreases the chirp and a decrease in temperature increases the chirp). Shown below are a couple of the many ways of implementing the variation of the chirp in relation to the change in temperature. It is assumed in the examples below that the packaging material has a variation in the stiffness of the material and/or coefficient of thermal expansion along the length of the grating and the packaging applies no stress to the grating at the time of packaging (temperature is in its “no stress” state).

Increasing the Chirp with an Increase in the Temperature

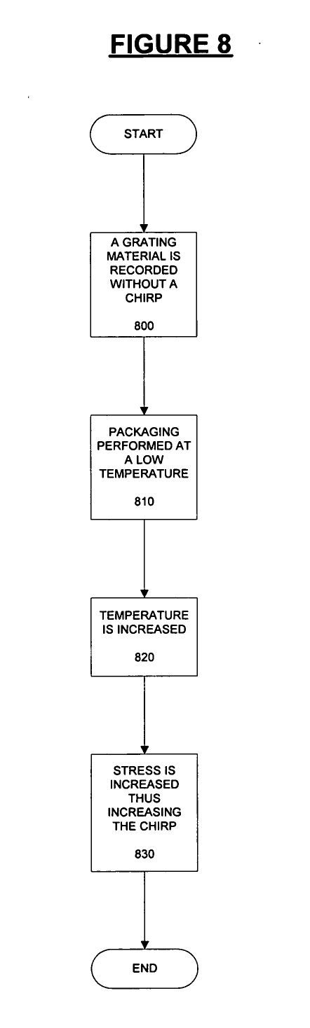

The grating is recorded without a chirp. The packaging material has a lower rate of thermal expansion than that of the grating material. In this case, the packaging can be performed at a low temperature, so that as the temperature increases, the stress increases because the packaging material expands slower than the grating material, but by different amounts along the length thus increasing the chirp. FIG. 8 illustrates the above example. At step 800, a grating material with a higher rate of thermal expansion than that of a packaging material is recorded without a chirp. At step 810, the packaging is performed at a low temperature. At step 820, the temperature is increased. At step 830, the stress automatically increases because the packaging material expands slower than the grating material, thus increasing the chirp. Decreasing the temperature has the opposite effect of decreasing the chirp.

Increasing the Chirp with a Decrease in the Temperature

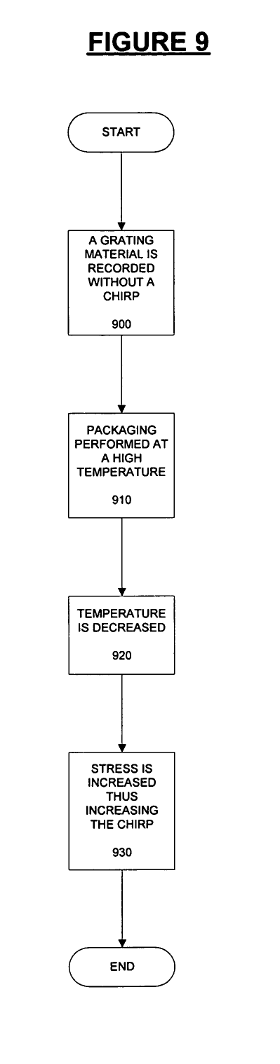

The grating is again recorded without a chirp. The packaging material has a higher rate of thermal expansion than that of the grating material. In this case, the packaging can be performed at a high temperature, so that as the temperature decreases, the stress increases because the packaging material shrinks faster than the grating material, but by different amounts along the length thus increasing the chirp. FIG. 9 illustrates the above example. At step 900, a grating material with a lower rate of thermal expansion than that of a packaging material is recorded without a chirp. At step 910, the packaging is performed at a high temperature. At step 920, the temperature is decreased. At step 930, the stress automatically increases because the packaging material shrinks faster than the grating material, thus increasing the chirp. Increasing the temperature has the opposite effect of decreasing the chirp.

In the examples above, the relative thermal expansion is between the packaging and grating materials. So, by going from increasing the chirp by increasing the temperature to decreasing the chirp by decreasing the temperature (or any other permutation), the chirp can be increased by either changing the grating material thermal expansion or the packaging material thermal expansion, or both.

Anisotropic Tubes

Anisotropic tubes are useful for minimizing frictional forces along the boundary of the filter-tube interface that act to prevent the filter from expanding or contracting along the longitudinal direction, thereby allowing more design flexibility.

Generating anisotropic tubes that have different thermal expansion coefficients radially than longitudinally can be accomplished using two of the several methods discussed below. In a first method, a tube is created with a stack of washers containing precise inner diameter openings. FIG. 2 illustrates a tube 200 created from a stack of individual washers 210 enclosing filter 220. In the figure the gap between the washers is exaggerated for clarity, but is actually microscopic.

In operation, the washers are held together using a soft solder, or any soft joining material that would physically yield at a low level in order to stabilize the washers and prevent buckling failure with large aspect ratios. In order to achieve the desired prevention of buckling failure, the stiffness of the joining material is less than the stiffness of the washer material. Since the tube is uniform in the radial direction but consists of a series of gaps, or filler material in the longitudinal direction, the overall average thermal expansion coefficient is not isotropic. The gaps absorb the thermal expansion between one washer and the next such that the center position of each washer is independent of temperature. The thickness of each washer and gap distance is based on the required operating temperature range and the properties of the materials used.

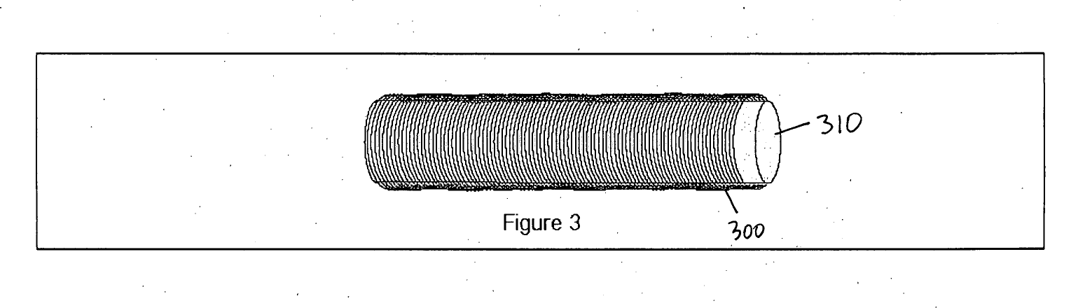

In a second method, a wire or thread is wrapped around a filter that forms a core. FIG. 3 illustrates a wire 300 wrapped around a core filter 310. In this method, the material does not have to be a single homogenous material, but can be a composite formed around the filter core, and can include adhesives and binders. The type of filter material, the thickness of the wire or thread, the number of layers of the wire around the core, the temperature during wrapping, and the pitch of the wrap can all be varied to tailor the assembly characteristics of the application and the final thermal wavelength coefficient required.

Clamp

According to another embodiment of the present invention, a clamp arrangement comprising of plates and means of attaching the plates together is used to modify the thermal wavelength coefficient. These attaching means can be screws, rivets, bolts, or any other attaching devices, and the plates can be made of steel, kovar, or any other material. In operation, the volume Bragg grating filter is placed between two low thermal-expansion-coefficient spacers. This stack is in turn placed between a pair of plates that is pressed together by the attaching means. The thickness of the spacers and the thermal expansion coefficient of the attaching means primarily determine the amount of stress applied to the filter with variations in temperature. The relative stiffness between the spacers and the attaching means also make an impact on the amount of stress applied. The operating point of the assembly is set by adjusting the tension on the means at a particular temperature. Also in operation, as the compressive force on the filter changes due to a change in temperature, the filter length changes and the Bragg wavelength shifts according to equation (4) above with a geometry dependent factor of 1.

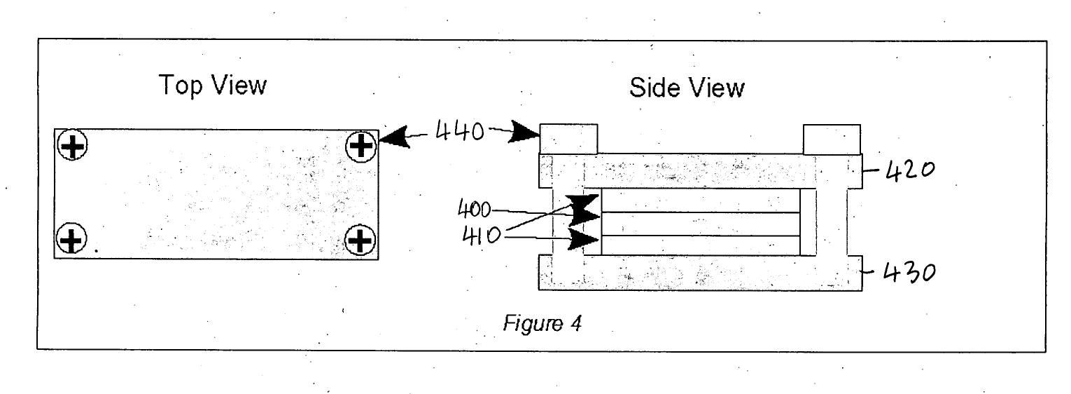

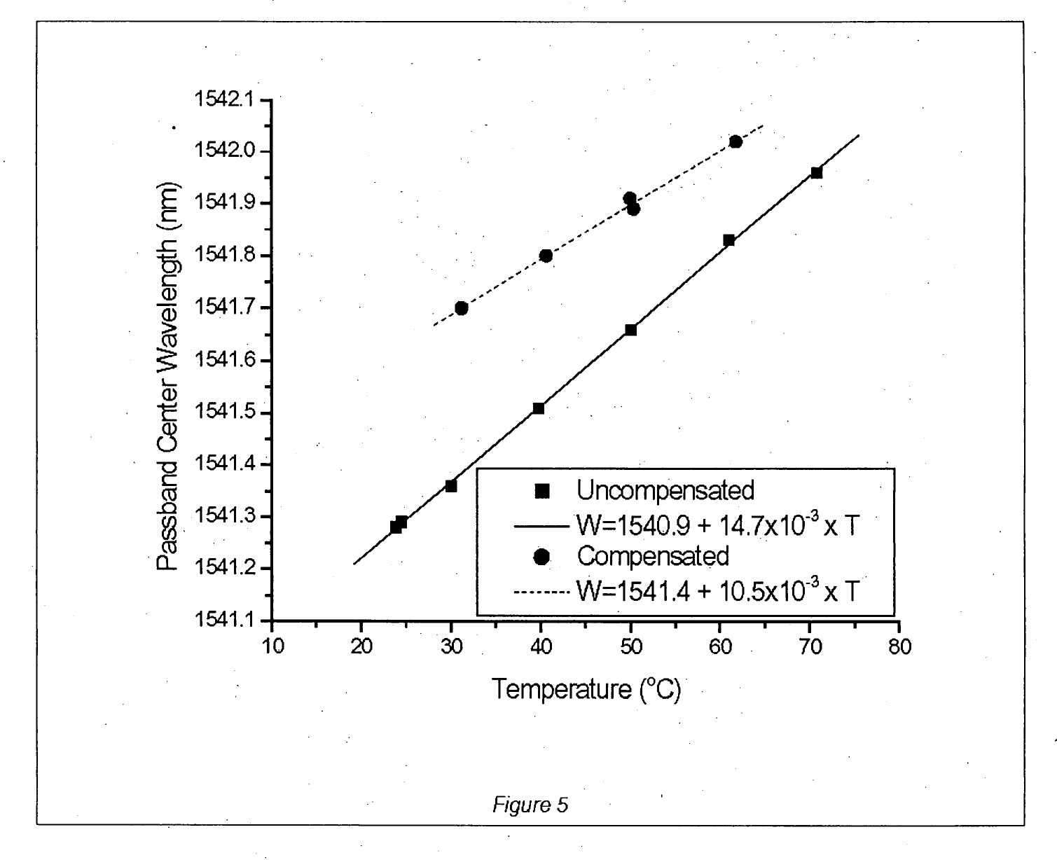

FIG. 4 illustrates a top and side view of the clamp arrangement discussed above. Filter 400 is sandwiched between spacers 410. Both filter and spacers are held in place between a top plate 420 and a bottom plate 430 of a clamp tightened by screws 440. According to one embodiment of the clamp, the screws (or any attaching means) and plates are made of steel with a relatively high thermal coefficient of expansion (16 ppm/° C.), while the spacers are made of quartz with a thermal coefficient of expansion close to zero (0.5 ppm/° C.). In an experiment conducted by the Applicants, the entire clamp assembly was raised to approximately 80° C. and the screws tensioned. When the temperature of the assembly was lowered, the compressive force on the filter increased due to the higher rate of contraction of the screws relative to the filter. When this happened, it caused the filter center wavelength to be longer than it would otherwise be in an unstressed state at an equivalent temperature. FIG. 5 illustrates a graph of the results of the above conducted experiment. The operating point in the experiment was varied by 0.5 nm at 0° C. and the graph shows a thermal wavelength coefficient modification from 14.7 pm/° C. (steeper angle of the solid line) in the uncompensated case to 10.5 pm/° C. (shallower angle of the dotted line) when compensated.

The thermal wavelength coefficient of the above clamp assembly can be modified by proper selection of the material of the attaching means and spacer, and the thickness of the spacer. One way to increase or decrease the thermal wavelength coefficient from that of the original filter material is to use negative expansion coefficient materials.

Compensating Substrate

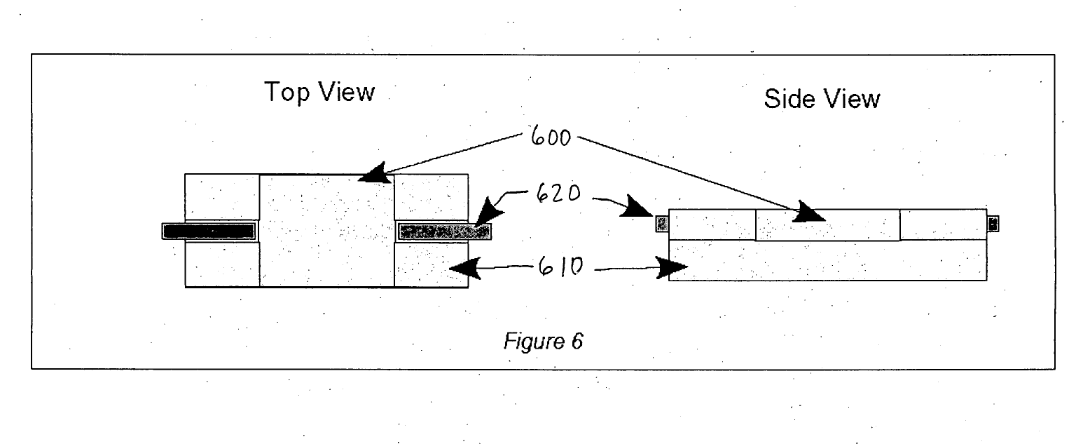

According to another embodiment of the present invention, a filter is inserted into a substrate with a lower thermal expansion coefficient. This approach is called the compensating substrate approach. In this approach, the thermal wavelength coefficient is modified according to the relative thermal expansion coefficients of the two materials (the filter and the substrate), their stiffness, and the geometry of the assembly. By varying these parameters, different values of the thermal wavelength coefficient can be obtained. FIG. 6 illustrates a top and side view of the compensating substrate approached discussed above where filter 600 is inserted into substrate 610 and is held in place with a set of collimators 620.

Compensating Sandwich

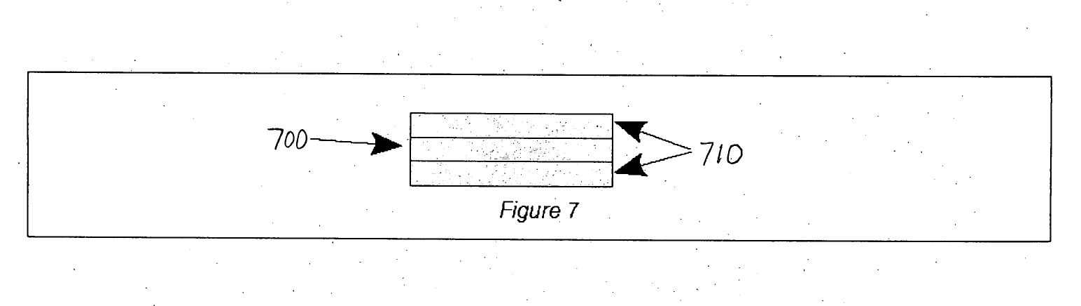

According to another embodiment of the present invention, a filter is bonded between two pieces of a substrate material with a different thermal expansion coefficient. This approach is called the compensating sandwich approach. In this approach, the bonded substrate acts to restrict or enhance the expansion of the filter with variations in temperature, thus modifying its thermal wavelength coefficient from that of the basic filter. By changing the materials and geometry of the assembly, the thermal wavelength coefficient can be tailored to the requirements of an application. The greatest affect can be achieved when the filter is very thin and the substrate slabs sandwiching the filter are very thick. FIG. 7 illustrates the compensating sandwich approach discussed above with filter 700 sandwiched between substrates 710.

Thus, a method for packaging volume holographic filters to modify temperature insensitivity is described in conjunction with one or more specific embodiments. The invention is defined by the following claims and their full scope of equivalents.

We claim:

1. A method to package a holographic filter, comprising the steps of:
recording a grating with a chirp on said filter;
applying a mechanical constraint to said filter; and
altering a thermal expansion of said filter.

2. The method of claim 1 wherein said filter is a simple reflection grating filter.

3. The method of claim 1 wherein said filter is a slanted reflection grating filter.

4. The method of claim 1 wherein said filter is a transmission grating filter.

5. The method of claim 1 wherein said filter is a fixed volume holographic grating filter (VHG).

6. The method of claim 1 wherein said filter is holographically recorded using a phase mask.

7. The method of claim 1 wherein said filter is holographically recorded using a two-beam method.

8. The method of claim 1 wherein said filter is thermally compensated by means of a tube geometry.

9. The method of claim 1 wherein said mechanical constraint further comprising: inducing a strain to tailor a thermal wavelength coefficient of said filter.

10. The method of claim 1 wherein said mechanical constraint further comprising: clamping said filter by a clamp to a pre-set value such that said clamp controls said thermal expansion in a direction of said filter and wherein said thermal wavelength coefficient is modified to be zero.

11. The method of claim 1 wherein said mechanical constraint further comprising: clamping said filter by a clamp to a pre-set value such that said clamp controls said thermal expansion in a direction of said filter and wherein said thermal wavelength coefficient is modified to be non-zero.

12. The method of claim 8 wherein said tube geometry further comprises a plurality of anisotropic tubes to minimize frictional forces along any boundary of said tubes.

13. The method of claim 12 wherein said plurality of anisotropic tubes are generated by wrapping a wire around said filter.

14. The method of claim 13 wherein said wire is not made from a homogenous material.

15. The method of claim 13 wherein said wire has a thickness that is not a fixed thickness.

16. The method of claim 13 wherein said wrapping of wire around said filter forms a layer whose thickness is not a fixed thickness.

17. The method of claim 13 wherein said wrapping of wire has a pitch that is not a fixed pitch.

18. The method of claim 13 wherein said wrapping of wire can be performed at any temperature.

19. The method of claim 12 wherein said plurality of anisotropic tubes are generated by stacking a plurality of washers, each of which have a same inner diameter opening.

20. The method of claim 19 wherein said plurality of washers are held together by a soft solder that physically yields at a low level so that each of said plurality of washers stabilizes and hence prevents a buckling failure.

21. The method of claim 20 wherein said soft solder has a stiffness level less than a stiffness level of each of said plurality of washers.

22. The method of claim 19 wherein a gap between each of said plurality of washers absorbs said thermal expansion such that center of each of said plurality of washers is independent of said thermal expansion.

23. The method of claim 22 wherein each of said plurality of washers have a thickness that is not a fixed thickness and said gap between them is not a fixed gap.

24. The method of claim 9 wherein said thermal wavelength coefficient is modified by a clamp arrangement comprising of a plurality of plates, a plurality of spacers, and a plurality of attaching means such that said filter is placed between a pair of spacers to form a stack which is in turn placed between a pair of plates that are pressed together by said plurality of attaching means at a temperature.

25. The method of claim 24 wherein said plurality of attaching means and said plurality of spacers are each made from a material with a negative expansion coefficient.

26. The method of claim 24 wherein said plurality of plates and said plurality of attaching means both have a first thermal coefficient of expansion and said plurality of spacers have a second thermal coefficient of expansion different from said first thermal coefficient of expansion.

27. The method of claim 26 wherein said first thermal coefficient of expansion is about 16 ppm/° C.

28. The method of claim 26 wherein said second thermal coefficient of expansion is about 0.5 ppm/° C.

29. The method of claim 5 wherein said filter is inserted into a substrate with a lower thermal expansion coefficient.

30. The method of claim 29 wherein said filter has a thermal wavelength coefficient dependant on said thermal expansion coefficient of substrate and said thermal expansion coefficient of filter, stiffness of said filter and stiffness of said substrate, and geometry of said filter and geometry of said substrate.

31. The method of claim 5 wherein said filter is bonded between a first and a second piece of substrate material wherein said first piece of substrate has a thermal expansion coefficient different from a thermal expansion coefficient of said second piece of substrate.

32. The method of claim 1 wherein recording said grating with a chirp is by a fixed amount determined by said filter.

33. The method of claim 1 wherein said package modifies said chirp with a change in temperature.

34. The method of claim 33 wherein said chirp is increased with an increase in said temperature.

35. The method of claim 33 wherein said chirp is increased with a decrease in said temperature.

36. The method of claim 33 wherein said chirp is decreased with an increase in said temperature.

37. The method of claim 33 wherein said chirp is decreased with a decrease in said temperature.

38. A method to package a holographic filter, comprising the steps of:
recording a grating without a chirp on said filter;
applying a mechanical constraint to said filter; and
altering a thermal expansion of said filter.

39. The method of claim 38 wherein said filter is a simple reflection grating filter.

40. The method of claim 38 wherein said filter is a slanted reflection grating filter.

41. The method of claim 38 wherein said filter is a transmission grating filter.

42. The method of claim 38 wherein said filter is a fixed volume holographic grating filter (VHG).

43. The method of claim 38 wherein said filter is holographically recorded using a phase mask.

44. The method of claim 38 wherein said filter is holographically recorded using a two-beam method.

45. The method of claim 38 wherein said filter is thermally compensated by means of a tube geometry.

46. The method of claim 38 wherein said mechanical constraint further comprising: inducing a strain to tailor a thermal wavelength coefficient of said filter.

47. The method of claim 38 wherein said mechanical constraint further comprising: clamping said filter by a clamp to a pre-set value such that said clamp controls said thermal expansion in a direction of said filter and wherein said thermal wavelength coefficient is modified to be zero.

48. The method of claim 38 wherein said mechanical constraint further comprising: clamping said filter by a clamp to a pre-set value such that said clamp controls said thermal expansion in a direction of said filter and wherein said thermal wavelength coefficient is modified to be non-zero.

49. The method of claim 45 wherein said tube geometry further comprises a plurality of anisotropic tubes to minimize frictional forces along any boundary of said tubes.

50. The method of claim 49 wherein said plurality of anisotropic tubes are generated by wrapping a wire around said filter.

51. The method of claim 50 wherein said wire is not made from a homogenous material.

52. The method of claim 50 wherein said wire has a thickness that is not a fixed thickness.

53. The method of claim 50 wherein said wrapping of wire around said filter forms a layer whose thickness is not a fixed thickness.

54. The method of claim 50 wherein said wrapping of wire has a pitch that is not a fixed pitch.

55. The method of claim 50 wherein said wrapping of wire can be performed at any temperature.

56. The method of claim 49 wherein said plurality of anisotropic tubes are generated by stacking a plurality of washers, each of which have a same inner diameter opening.

57. The method of claim 56 wherein said plurality of washers are held together by a soft solder that physically yields at a low level so that each of said plurality of washers stabilizes and hence prevents a buckling failure.

58. The method of claim 57 wherein said soft solder has a stiffness level less than a stiffness level of each of said plurality of washers.

59. The method of claim 56 wherein a gap between each of said plurality of washers absorbs said thermal expansion such that center of each of said plurality of washers is independent of said thermal expansion.

60. The method of claim 59 wherein each of said plurality of washers have a thickness that is not a fixed thickness and said gap between them is not a fixed gap.

61. The method of claim 46 wherein said thermal wavelength coefficient is modified by a clamp arrangement comprising of a plurality of plates, a plurality of spacers, and a plurality of attaching means such that said filter is placed between a pair of spacers to form a stack which is in turn placed between a pair of plates that are pressed together by said plurality of attaching means at a temperature.

62. The method of claim 61 wherein said plurality of attaching means and said plurality of spacers are each made from a material with a negative expansion coefficient.

63. The method of claim 61 wherein said plurality of plates and said plurality of attaching means both have a first thermal coefficient of expansion and said plurality of spacers have a second thermal coefficient of expansion different from said first thermal coefficient of expansion.

64. The method of claim 63 wherein said first thermal coefficient of expansion is about 16 ppm/° C.

65. The method of claim 63 wherein said second thermal coefficient of expansion is about 0.5 ppm/° C.

66. The method of claim 42 wherein said filter is inserted into a substrate with a lower thermal expansion coefficient.

67. The method of claim 66 wherein said filter has a thermal wavelength coefficient dependant on said thermal expansion coefficient of substrate and said thermal expansion coefficient of filter, stiffness of said filter and stiffness of said substrate, and geometry of said filter and geometry of said substrate.

68. The method of claim 42 wherein said filter is bonded between a first and a second piece of substrate material wherein said first piece of substrate has a thermal expansion coefficient different from a thermal expansion coefficient of said second piece of substrate.

69. The method of claim 38 wherein said package causes said grating to become chirped with a change in temperature.

70. The method of claim 69 wherein said chirp is increased with an increase in said temperature.

71. The method of claim 69 wherein said chirp is increased with a decrease in said temperature.

72. The method of claim 69 wherein said chirp is decreased with an increase in said temperature.

73. The method of claim 69 wherein said chirp is decreased with a decrease in said temperature.
